(19) United States
(12) Patent Application Publication
(10) Pub. No.: US 2026/0125598 A1
(43) Pub. Date: May 7, 2026

(54) PLASTIC WASTE FOR FROST MITIGATION

(71) Applicants: Elham Fini, Phoenix, AZ (US); Farideh Pahlavan, Chandler, AZ (US); Mohammadjavad Kazemi, Tempe, AZ (US)

(72) Inventors: Elham Fini, Phoenix, AZ (US); Farideh Pahlavan, Chandler, AZ (US); Mohammadjavad Kazemi, Tempe, AZ (US)

(21) Appl. No.: 19/373,482

(22) Filed: Oct. 29, 2025

Related U.S. Application Data
(60) Provisional application No. 63/715,471, filed on Nov. 1, 2024.

(51) Int. Cl. C09K 17/40; C09K 103/00

(52) U.S. Cl. CPC C09K 17/40; C09K 2103/00

(57) ABSTRACT

A mixture includes carbon-coated oil-treated plastic particles and particles that include geomaterial. Treating the soil at a building site includes combining carbon-coated oil-treated plastic particles and geomaterial particles to yield a mixture and providing the mixture in a built environment to enhance soil stability under freezing conditions.

### CROSS-REFERENCE TO RELATED APPLICATION

This application claims the benefit of U.S. Patent Application No. 63/715,471 filed on Nov. 1, 2024, which is incorporated by reference herein in its entirety.

### STATEMENT OF GOVERNMENT SUPPORT

This invention was made with government support under 1935723 awarded by the National Science Foundation. The government has certain rights in the invention.

### TECHNICAL FIELD

This invention relates to carbon-coated, bio-grafted plastic granules for suppression of freezing in frost-susceptible soils.

### BACKGROUND

In cold climates, phase changes of water-to-ice and ice-to-water in the pore structures of soils challenge the integrity and longevity of infrastructure. Soils in these regions undergo volumetric changes at least in part because of climatic stressors, impacting structures such as building foundations, bridges, pipelines, railways, dams, and pavement subgrades.

### SUMMARY

This disclosure describes the use of waste plastic coated with biogenic carbon as a functional material for soils susceptible to frost heave and freeze-thaw. This bio-inspired approach draws inspiration from ice-binding proteins found in polar organisms, using principles of surface science to develop carbon-coated oil-treated plastic granules (C-OTPG) aimed at lowering the freezing point in frost-susceptible geomaterials. C-OTPG can effectively mimic the function of ice binding proteins by disrupting ice nucleation and crystal growth through interactions among C-OTPG's functional groups, water, and the siliceous substrate. This approach bolsters the resilience of geomaterials in cold climates while repurposing waste materials for sustainable applications. A Linkam Peltier LTS120 thermoelectrical cooling device and bright-field microscopy was used to measure freezing temperatures and thawing temperatures and to assess the ice-inhibition properties of both silt and fine sand treated with C-OTPG. For silt, C-OTPG treatment reduced the freezing point by up to 39% and increased thermal hysteresis by up to 65%, while for fine sand, the freezing point was reduced by up to 52% and thermal hysteresis increased by up to 38%. Calculations using density functional theory show strong hydrogen bonding and polar interactions between biogenic carbon and water molecules, preventing movement of water to the frost front and disrupting the formation of ice crystals. Additionally, biogenic carbon competes for adsorption sites on silica surfaces of sand and silt, while “capping” water molecules already on a silica surface inhibiting ice formation.

In a first general aspect, a mixture includes carbon-coated oil-treated plastic particles and particles including geomaterial.

Implementations of the first general aspect can include one or more of the following features.

The carbon-coated oil-treated plastic particles can include polyethylene terephthalate particles coated with waste vegetable oil and biogenic carbon. The biogenic carbon can be derived from algal biomass. The geomaterial can include silt, soil, sand, or any combination thereof. The carbon-coated oil-treated plastic particles can lower the freezing point of the geomaterial. In some cases, the carbon-coated oil-treated plastic particles raise the thawing point of the geomaterial. In some implementations, the carbon-coated oil-treated plastic particles suppress ice crystallization at a surface of the particles including geomaterial. A particle size of the carbon-coated oil-treated plastic particles can be in a range of 250 μm to 350 μm. The mixture can include 5 wt % to 75 wt % of the carbon-coated oil-treated plastic particles. In certain cases, the mixture includes 20 wt % to 50 wt % of the carbon-coated oil-treated plastic particles.

In a second general aspect, treating the soil at a building site includes combining carbon-coated oil-treated plastic particles and geomaterial particles to yield a mixture and providing the mixture in a built environment to enhance soil stability under freezing conditions.

Implementations of the second general aspect can include one or more of the following features.

The carbon-coated oil-treated plastic particles can include polyethylene terephthalate particles coated with waste vegetable oil and biogenic carbon. The biogenic carbon can be derived from algal biomass. The geomaterial particles can include silt, soil, sand, or any combination thereof. A particle size of the carbon-coated oil-treat plastic particles can be in a range of 250 μm to 350 μm. In some cases, combining the carbon-coated oil-treated plastic particles and geomaterial particles lowers the freezing point of the geomaterial in the geomaterial particles. In some implementations, combining the carbon-coated oil-treated plastic particles and geomaterial particles raise the thawing point of geomaterial in the geomaterial particles. Combining the carbon-coated oil-treated plastic particles and geomaterial particles can suppress ice crystallization at a surface of the geomaterial particles. In some cases, the mixture includes 5 wt % to 75 wt % of the carbon-coated oil-treated plastic particles. In certain implementations, the mixture includes 20 wt % to 50 wt % of the carbon-coated oil-treated plastic particles.

Freezing point suppression in soils susceptible to frost heave is assessed using oil-treated plastic granules coated with biogenic carbon derived from algae. These granules are designed to enhance soil stability under freezing conditions by lowering the freezing point. Carbon-coated oil-treated plastic granules allow enhancement of the resilience of civil infrastructure against frost action while concurrently addressing environmental concerns associated with end-of-life plastics.

When treated with C-OTPG, both silt and fine sand exhibit lower freezing points than control soil due at least in part to the thermal resistance introduced by the C-OTPG. The interplay between C-OTPG and the soil's grain size and surface area contributes to the lowering of the freezing point, with treated silt showing a higher freezing point (e.g., −10.12° C.) than treated fine sand (e.g., −14.88° C.).

The percentage of C-OTPG used plays a role in lowering the freezing point of C-OTPG-soil composites. While this effect is less pronounced in treated silt, fine sand treated with lower amounts of C-OTPG exhibits a lower freezing point compared to treatment with higher amounts of C-OTPG.

The thermal resistance of C-OTPG also affects thawing points; silt treated with 50% C-OTPG content exhibits a higher thawing point compared to silt treated with 20% C-OTPG content. Fine sand shows negligible variation in thawing point between 20% C-OTPG and 50% C-OTPG content.

The thermal hysteresis activity, which is maximized at 50% C-OTPG for treated silt, underscores the intricate relationship between C-OTPG dosage and grain properties in influencing the freezing point and thawing point of treated soil samples.

Molecular modeling indicates that biogenic carbon preferentially adsorbs onto silica surfaces in competition with water molecules. This interaction disturbs the alignment of water at the surface, effectively suppressing ice crystallization at the silica interface. This mechanism further demonstrates biogenic carbon's role in controlling the dynamics of ice formation.

Density functional theory (DFT) calculations show interactions between water molecules and the biogenic carbon in C-OTPG. Functional groups such as amide, amine, and carboxyl on the biogenic carbon form strong hydrogen bonds with water. This mechanism decreases the mobility of water, thereby contributing to the depression of the freezing point in soil.

DFT results show that the propensity of biogenic carbon to interact with water molecules, stemming from its hydrogen-bond donor and acceptor functional groups, enables it to cap water layers adsorbed on the silica surface. This capping action blocks the growth of ice, demonstrating another avenue that biogenic carbon can use to manipulate the dynamics of ice formation at the molecular level.

The coating of biogenic carbon on the C-OTPG can serve as both a physical barrier and a chemical barrier, obstructing the growth of ice crystals. This dual barrier can not only provide a physical impediment to the expansion of ice crystals, but also engage in chemical interactions with water molecules. Drawing parallels to the ways ice-binding proteins safeguard living cells from freezing damage, C-OTPG could bolster the durability and structural integrity of construction materials facing freeze-thaw cycles by limiting the formation and growth of ice within the material matrix. The use of C-OTPG as an antifreeze in non-biological systems leverages engineered surface properties to emulate the ice binding and the inhibition of crystal growth observed with ice-binding proteins. By sequestering carbon within plastics, C-OTPG can not only suppress the freezing point but also contribute to carbon storage. This approach offers a sustainable solution for soil stabilization while supporting resource conservation and recycling.

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF DRAWINGS

FIG. 1A is a flow chart showing operations in a process for treating soil at a building site. FIG. 1B is a schematic representation of an algal biogenic carbon model. Each ‘Interaction Sphere’, outlined by a dashed line, identifies interaction regions on biogenic carbon. Enlargements show detailed molecular structures, including functional groups, highlighting areas of electronic influence and bonding potential. Interaction Spheres are labeled A, B, C, and D for clarity. FIG. 1C is the optimized structure of a silica surface as calculated at the Perdew-Burke-Ernzerhof (PBE)-D/DNP level of theory. FIG. 1D is an illustration of the zig-zag hydrogen bonding pattern among hydroxyl groups on the silica surface.

FIG. 2A shows the effect of low or high dosage of carbon-coated oil-treated plastic granules (C-OTPG) on the freezing point of soil. The maximum, minimum, and average calculated standard deviations (σ) for this data set are σₘₐₓ=0.15, σₘᵢₙ=0.03, and σ_{avg}=0.07, respectively. FIG. 2B shows the effect of low or high dosage of C-OTPG plastics on the thawing point of soil. The maximum, minimum, and average calculated standard deviations (σ) for this data set are σₘₐₓ=0.13, σₘᵢₙ=0.02, and σ_{avg}=0.06, respectively.

FIG. 3A shows the effect of different amounts of C-OTPG on thermal hysteresis activity of soil. FIG. 3B shows the normalized freezing properties of plastic-treated silt and plastic-treated fine sand. FIG. 3C shows the normalized thawing properties of plastic-treated silt and plastic-treated fine sand.

### DETAILED DESCRIPTION

This disclosure describes a composite material including polyethylene terephthalate (PET) granules treated with oil, and biogenic carbon derived from algae biomass. The integration of these two materials improves the thermal-insulation properties of PET and the ice-binding properties of biogenic carbon to enhance the resilience of frost-susceptible soils. The coating of biogenic carbon, disrupts ice nucleation and growth by forming strong hydrogen bonds with water molecules, thereby preventing or inhibiting the formation of ice crystals. This dual-function approach aims to lower the freezing point of the treated soils and increase the soils' thawing point, effectively reducing the adverse effects of freeze-thaw cycles on civil infrastructure.

As an additive, oil-treated plastic granules can improve an asphalt binder's resistance to aging: the binder modified with oil-treated plastic granules retains a greater healing capacity after prolonged exposure. Additionally, oil-treated plastic granules decrease moisture damage. A mechanism by which oil-treated plastic granules mitigates aging (e.g., from solar radiation) is through enhanced retention of bitumen's volatile organic compounds via adsorption onto the surface of the oil-treated PET granules. The use of PET in the subgrade soil of infrastructures in cold climates targets the suppression of ice formation. This approach fortifies the resilience of subgrade soils against the challenges of freeze-thaw cycles by exploiting PET's thermal-insulation qualities, which can be attributed at least in part to its low thermal conductivity. As an asphalt modifier, PET enhances mixture stiffness (leading to improved resistance to fatigue and rutting) and reduces moisture susceptibility by modifying the bitumen-aggregate interface. The application of PET in subgrade soil is designed to achieve advancements in structural integrity and durability. Plastic acts as a thermal insulator, helping to control heat transfer in both positive temperatures and negative temperatures.

Algae-based biogenic carbon can enhance the performance of asphalt binders by improving their resistance to aging and increasing their durability. Biogenic carbon's structural properties, such as its high surface area and the presence of functional groups, contribute to its capability to interact effectively with bitumen and other components of asphalt. Biogenic carbon interacts with the volatile organic compounds in asphalt, preventing their emission and thereby decreasing mass loss and ultraviolet aging. The incorporation of biogenic carbon not only helps with the management of waste but also contributes to the resilience of infrastructure materials. The use of algae-derived biogenic carbon can be extended to stabilization of subgrade soils by suppressing ice formation and enhancing the thermal properties of frost-susceptible soils.

Measurements and computational analyses are conducted to assess the efficacy of carbon-coated oil-treated plastic granules (C-OTPG) at suppressing ice formation. Measurements use a Linkam Peltier LTS120 thermoelectrical cooling device and a bright-field microscope to evaluate the thermal characteristics (e.g., freezing temperature and thawing temperature) and ice-inhibition properties of siliceous samples treated with C-OTPG. Concurrently, molecular modeling using density functional theory (DFT) calculations provides insight into the interactions and mechanisms underlying the ice-suppression capabilities of C-OTPG. This combined approach elucidates the dynamics and effectiveness of this composite material at enhancing the durability and structural integrity of construction materials in cold climates.

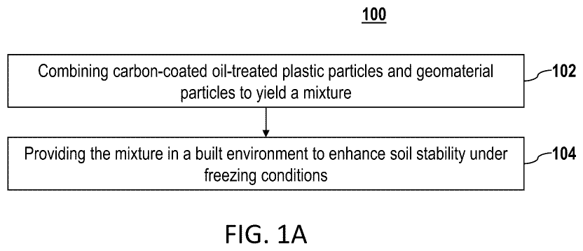

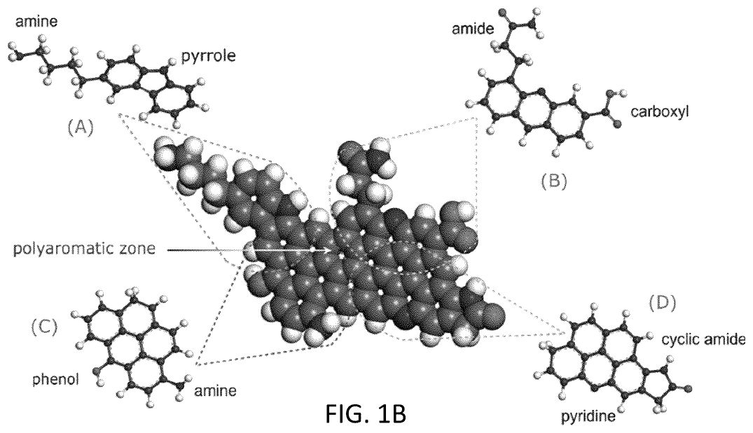

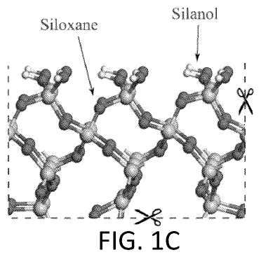

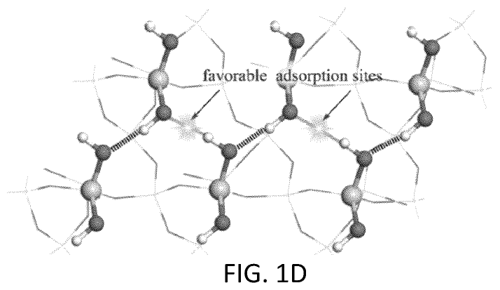

FIG. 1A is a flow chart showing operations in a process 100 for treating soil at a building site. In 102, carbon-coated oil-treated plastic particles and geomaterial particles are combined to yield a mixture. In 104, the mixture is provided in a built environment to enhance soil stability under freezing conditions.

The carbon-coated oil-treated plastic particles include polyethylene terephthalate particles coated with waste vegetable oil and biogenic carbon. The biogenic carbon can be derived from algal biomass. Geomaterial particles can include silt, soil, sand, or any combination thereof. A particle size of the carbon-coated oil-treat plastic particles is typically in a range of 250 μm to 350 μm (e.g., 297 μm to 300 μm). In some cases, combining the carbon-coated oil-treated plastic particles and geomaterial particles lower the freezing point of the geomaterial in the geomaterial particles. In some implementations, combining the carbon-coated oil-treated plastic particles and geomaterial particles raise the thawing point of geomaterial in the geomaterial particles. Combining the carbon-coated oil-treated plastic particles and geomaterial particles can suppress ice crystallization at a surface of the geomaterial particles. The mixture typically includes 5 wt % to 75 wt % (e.g., 3 wt % to 10 wt %, 10 wt % to 20 wt %) of the carbon-coated oil-treated plastic particles. In certain cases, the mixture includes 20 wt % to 50 wt % of the carbon-coated oil-treated plastic particles.

### Examples

Pure silt and fine sand, as representative siliceous geomaterials, were purchased from Ward's Science, Rochester, NY. Polyethylene terephthalate (PET) flakes were obtained from Envision Plastics Inc. in North Carolina. Waste vegetable oil, which served as the bio-oil in these measurements, was obtained from Mahoney Environmental Inc., Phoenix, Arizona. Biogenic carbon sourced from the red alga Cyanidioschyzon merolae was produced under controlled conditions via hydrothermal liquefaction. The biomass was converted into biogenic carbon at a temperature of 330° C. and a pressure of 9 MPa, using ultra-high-purity nitrogen to maintain an inert environment. Once the reaction concluded, dichloromethane was used to separate the biogenic carbon from the liquid phase. Cyanidioschyzon merolae cultivation occurred in 50-L vertical photobioreactors at the Arizona Center for Algae Technology and Innovation, Arizona State University. Initially, stock cultures were cultivated indoors on tissue-culture plates and subsequently transferred to outdoor reactors. These reactors were enriched with 2% to 3% CO₂ and maintained at 40° C. under a cycle of 14 hours light (up to 450 μmol photons m⁻² s⁻¹) and 10 hours dark. The biogenic carbon from algae underwent a process of grinding and fractionation. Granules passing through sieve size No. 200 (0.075 mm) were collected and securely stored in sealed bags to prevent any contamination.

To initiate the preparation of carbon-coated oil-treated plastic granules (C-OTPG), PET particles were combined with waste vegetable oil at a 1:1 mass ratio. This mixture was stored at an ambient temperature for 12 hours. Following that, the functionalization of plastic particles with bio-oil molecules was carried out using microwave irradiation at 400 watts, conducted in two stages for a total duration of 10 minutes. Initially, the mixture was irradiated for 5 minutes, followed by removal from the microwave and stirring for 10 minutes. After stirring, the mixture underwent another 5 minutes of irradiation, after which it was allowed to cool at ambient temperature for 2 hours. The resultant mixture was ground and washed with acetone to eliminate any unreacted bio-oil molecules. The washed mixture was then dried in an oven at 60° C. for 15 minutes. Granules of oil-treated plastic were sieved using the standard U.S. mesh series; granules passed through sieve size number 30 (sieve opening of approximately 600 μm) and were retained on sieve size number 50 (sieve opening of approximately 297 μm to 300 μm). Following this, the oil-treated plastic granules were coated with biogenic carbon. The process started by mixing a 1:2 mass ratio of biogenic carbon to OTPG in a beaker containing a solution of 60 wt % acetone and 40 wt % distilled water, followed by stirring for 10 minutes. Subsequently, the mixture underwent sonication using a Branson CPX2800H digital benchtop ultrasonic cleaner with timer and heater, maintaining a temperature of 50° C. for 15 minutes. The mixture was then left at ambient temperature for 24 hours before undergoing a further round of sonication for 90 minutes. Finally, the mixture was removed from the container, and the samples coated with biogenic carbon were dried at 100° C. for 1 hour. After drying, the samples were sieved. Particles passing through sieve number 30 (sieve opening of approximately 600 μm) but retained on sieve number 50 (sieve opening of approximately 297 μm to 300 μm) were designated as C-OTPG.

The impact of C-OTPG on the thermal characteristics of siliceous geomaterials with varying particle sizes was evaluated. Two volumetric ratios of C-OTPG, each with distinct properties, were incorporated into two types of non-plastic soils: silt, and fine sand. The average grain size was 0.05 mm for silt and 0.25 mm for fine sand. The specific gravity is 2.51 g/cm³ for silt and 2.63 g/cm³ for fine sand. Table 1 shows the mineral composition for the silt and fine sand; they are primarily composed of SiO₂, as confirmed by X-ray diffraction. The test methodology included subjecting the geomaterials to X-rays with different intensities and wavelengths and evaluating the elastic scattering, scattering angle, and diffraction patterns to identify the crystalline material. Throughout the experiments, deionized water was used to eliminate the effects of dissolved minerals on the experiment results.

TABLE 1
Mineralogy of Sand and Silt based on X-Ray Diffraction

| Minerals (wt. %) | Silt | Fine Sand |
|---|---|---|
| SiO₂ | 51.39 | 79.15 |
| NaAlSi₃O₈ | 31.79 | 12.77 |
| K(AlSi₃O₈) | 6.90 | 3.39 |
| Mg₅Al(AlSi₃O₁₀)(OH)₈ | 5.32 | 0 |
| CaCO₃ | 0 | 2.15 |
| Fe₃O₄ | 4.20 | 1.54 |
| Ca₂Al₄(SiO₄)₄ | 0.40 | 1.00 |

The impact of C-OTPG on the properties of soil by mixing carbon-coated oil-treated plastic granules with each soil type at volumetric ratios of 1:4 (20% C-OTPG) and 1:1 (50% C-OTPG) was assessed. These ratios were selected to compare the impact of different quantities of plastic on thermal behavior. To measure the thermal properties of soils treated with C-OTPG, a thermoelectrically controlled cooling device was used (Linkam LTS120). This setup has a temperature controller that allows for precise adjustments, a cooling chamber, a water pump for heat dissipation, and a microscope with a camera to observe and record phase transitions in real time. The experiments used a Peltier cooling stage in the device; it is capable of varying temperatures from 120° C. to −40° C. with an accuracy of ±0.01° C.

Test samples of silt and sand were prepared by mixing 20 μL of deionized water with 20 mg of control soil and plastic-treated soil at 18% and 8%, respectively. These samples were placed on a glass plate in the Peltier stage, and a temperature ramp of 1° C./minute was maintained to observe phase changes in the porous media. The chosen temperature ramp was validated by preliminary measurements to ensure accurate observation of phase changes. Duplicate tests were conducted to ensure repeatability.

Phase changes were monitored at four points: Ice Nucleation Initiation, Ice Nucleation Completion, Thawing Initiation, and Thawing Completion. ‘Ice Nucleation Initiation’ refers to the initial formation of ice on the sample surface. When ice formation has progressed to polygonal ice shapes at lower temperatures, that point is ‘Ice Nucleation Completion’. During the thawing period, ice crystals begin to melt at ‘Thawing Initiation’ and completely disappear by ‘Thawing Completion’, indicating the end of the thawing process. The temperature at ‘Ice Nucleation Initiation’ is the ‘Freezing Point’ of a sample. The temperature at ‘Thawing Completion’ is the ‘Thawing Point’ of a sample. The thermal hysteresis activity was quantified using Equation (1). Equations (2) and (3) helped analyze the effects of plastics on the freezing rate and thawing rate.

$$Thermal Hysteresis Activity = Thawing Point - Freezing Point \qquad ( 1 )$$

$$Normalized Freezing = \frac{\begin{matrix}( Ice Nucleation Initiation - Ice Nucleation Completion ) \\ of mix design\end{matrix}}{\begin{matrix}( Ice Nucleation Initiation - Ice Nucleation Completion ) \\ of geomaterial\end{matrix}} \qquad ( 2 )$$

$$( 3 )$$

$$Normalized Thawing = \frac{\begin{matrix}( Thawing Initiation - Thawing Completion ) \\ of mix design\end{matrix}}{\begin{matrix}( Thawing Initiation - Thawing Completion ) \\ of geomaterial\end{matrix}}$$

All molecular structures and interaction configurations were optimized using the DMol3 module in the Accelrys Materials Studio program package. DFT-based calculations used the Perdew-Burke-Ernzerhof (PBE) formulation of the generalized gradient approximation (GGA) and all-electron double numerical basis sets with polarization functions (DNP). Grimme's long-range dispersion correction was incorporated in the optimizations to ensure accurate estimation of thermodynamically stable interaction complexes, denoted as PBE-D. The optimization parameters were set at the “fine” level of integration, with tolerances for energy, maximum force, and displacement convergence set at 1.0×10⁻⁵ Hartree, 2.0×10⁻³ Hartree/Å, and 5.0×10⁻³ Å, respectively. To model and assess the competitive adsorption of water molecules and biogenic carbon over a model of a silica surface, periodic dispersion-corrected density functional theory calculations available in the DMol3 module were used, and electron smearing of 0.005 Hartree was used. Brillouin-zone integration used a default k-point grid of 1×2×1 for the fine-level DMol3 calculations. The adsorption energy, denoted as E_{ads}, played a role as a computational parameter in assessing two processes: the affinity of biogenic carbon to adsorb onto a hydroxylated silica surface, and the propensity of biogenic carbon to adsorb water molecules. These processes have the potential to disrupt ice crystallization by interfering with ice nucleation and growth within soil/silt matrices. E_{ads} is the energy difference between an interacted complex and its constituents (biogenic carbon, water, or silica) in their most stable energy state, as shown in Equation (4).

$${E}_{ads} = {E}_{int . complex} - ( {E}_{biogenic carbon} + {E}_{water or silica} ) \qquad ( 4 )$$

To evaluate the capability of algal biogenic carbon to suppress ice formation and retain water in soil, a molecular model representative of functionalized biogenic carbon derived from algal biomass was constructed. This model is based on elemental composition, atomic ratios, and functional groups determined through analytical techniques such as Fourier transform infrared spectroscopy (FTIR) and X-ray diffraction (XRD). A decrease in the hydrogen/carbon atomic ratio and the presence of graphitic carbon, evidenced by XRD peaks at 26.426° and 43.019° (2θ), suggested randomly oriented polyaromatic clusters. These findings support a structure including a central amorphous aromatic zone surrounded by functional groups. Biogenic carbon functional groups exhibit a heterogeneous composition, imparting hydrophobic, hydrophilic, basic, or acidic characteristics. These groups, including amides, amines, pyrroles, pyridines, hydroxyls, phenols, carbonyls, and carboxyls, play a role in adsorption. The high protein content in algal biomass leads to increased nitrogen-containing functional groups, enhancing adsorption capacity. Carbohydrates present in the microalgae also help retain nitrogen during the biomass's thermochemical conversion. The molecular model of algae-based biogenic carbon includes a polyaromatic graphene-like sheet decorated with major N-based functional groups and major O-based functional groups, as shown in FIG. 1A.

In the computational models to compare the interactions of biogenic carbon with water molecules and silica surfaces, each biogenic carbon functional group was incorporated along with its surrounding region, which is referred to as the ‘Interaction Sphere’, as presented in FIG. 1B. This approach captured a realistic electronic environment, as the vicinity of a functional group influences its electron distribution, partial charges, and overall polarity. Such details provide an insight into how these groups interact through mechanisms such as hydrogen bonding and van der Waals forces. Including the surrounding regions of functional groups ensured that all electronic and steric factors that affect the reactivity and interaction strength are considered, leading to more accurate predictions of adsorption properties and interaction potentials. By considering these local environments, simulations can more accurately reflect the complex dynamics at play, enhancing understanding of the molecular mechanisms behind the adsorption processes and the influence of surface interactions.

A molecular model of a cleaved quartz (001) surface characterized by coordinatively unsaturated Si and O atoms with dangling bonds resulting from the breaking of Si—O—Si bonds was used. When exposed to water, this surface undergoes a transformation where the under-coordinated Si atoms bind to hydroxyl groups (OH) while nearby non-bridging oxygen atoms react with hydrogen, forming two hydrogen-bonded silanol groups (Si—OH). This reaction continues until the surface is fully hydroxylated, typically terminating in silanol and siloxane (Si—O—Si) links, as shown in FIG. 1C. Silanol groups are more accessible than the siloxane links and play a role in the surface's interactions with water and the biogenic carbon. Silanol groups have the capability to form strong hydrogen bonds with polar functional groups and H₂O molecules.

To explore the hydrophilic interactions of the silica surface in the presence of the C-OTPG coating of biogenic carbon, a model of a hydroxylated quartz surface was optimized using density functional theory (DFT) periodic calculations. This modeling revealed a zig-zag network of hydrogen bonding on the (001) surface, with alternating weak and strong bonds, as illustrated in FIG. 1D. The weakly bonded sites are energetically more favorable for water and biogenic carbon adsorption, making them more probable and more stable for these interactions.

C-OTPG influenced the thermal behavior of soil, leading to a lower freezing point in plastic-soil composites compared to control soil. This effect varied with grain sizes and soil surface areas. Compared to fine sand, silts have a smaller grain size and higher surface area; thus, silts efficiently disperse thermal energy through numerous contact points between soil grains and water particles. In contrast, fine sand has fewer contact points, resulting in less-efficient dispersion of thermal energy and consequently a lower freezing point than silt.

Ice formation, freezing point, thawing point, and thermal hysteresis activity for both control soil samples and treated-soil samples are assessed. During the frozen stage, patterns of ice formation were observed in both the control samples and the treated-soil samples. The formation of polygonal-shaped ice crystals that are predominantly hexagonal occurred at the end of the ‘Ice Nucleation Completion’ stage. Fine sand had larger ice crystals and larger voids compared to silt, indicating the influence of grain size and pore-size distribution on thermal characteristics. Water tends to form hexagonal-shaped ice and continues to grow unless influenced by substantial pressure or materials such as antifreeze proteins. In silts, the size and growth rate of ice crystals are smaller compared to fine sand, which has a larger grain size and smaller surface area. As with the more rapid dispersion of thermal energy through silts compared to fine sand, ice growth or phase change in silts tends to end earlier compared to fine sand. However, the introduction of C-OTPG inversely altered this behavior in both soil types, indicating that plastics can control the transformation of heat energy through the soil-plastic composites. Silt treated with C-OTPG produced larger ice crystals compared to control silt. Fine sand treated with C-OTPG produced smaller ice crystals compared to control fine sand.

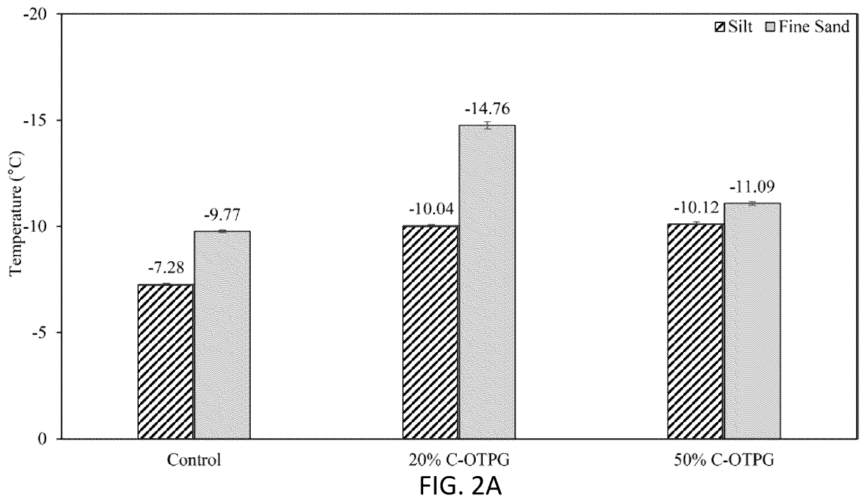

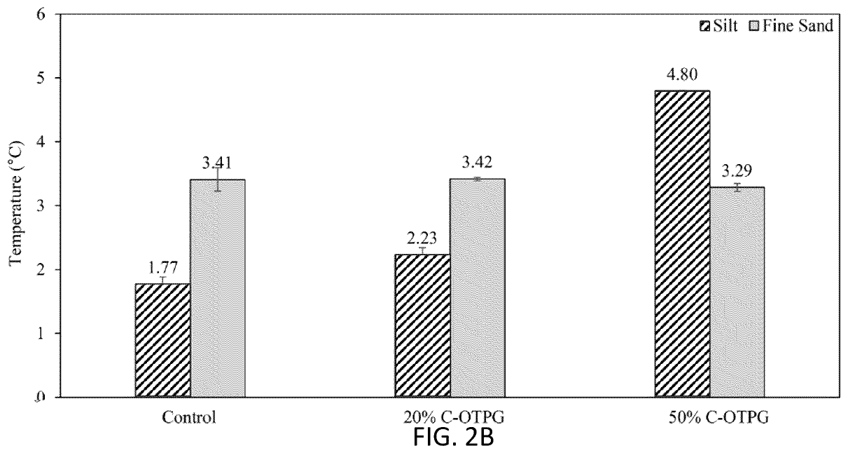

The freezing points of the control samples are −7.28° C. for silt, −9.77° C. for fine sand, and −12.55° C. for C-OTPG. FIG. 2A shows the freezing points of the control soils and soils treated with C-OTPG. Soils treated with C-OTPG exhibited lower freezing points compared to the control samples at least in part because of the thermal resistance introduced by the plastic granules.

Soils treated with C-OTPG consistently exhibited lower freezing points than the untreated control samples. C-OTPG-treated fine sand exhibited a greater depression in freezing point compared to C-OTPG-treated silt. Changing the plastic proportion (20% or 50% C-OTPG) had a negligible effect on the thermal behavior of silt, whereas fine sand demonstrated a more pronounced freezing point depression at lower proportions of plastic.

FIG. 2B shows the thawing points for control soils and treated soils. The control samples of silt, fine sand, and C-OTPG registered thawing points at 1.77° C., 3.41° C., and 3.44° C., respectively. Treated samples showed varied thawing behavior. Silt treated with C-OTPG recorded thawing points of 2.23° C. for mixtures with 20% plastic content and 4.8° C. for mixtures with 50% plastic content. C-OTPG treatments raised the thawing points compared to the controls, with C-OTPG-treated silt showing a greater variation in thawing temperatures (2.57° C. difference) between samples with low plastic content and samples with high plastic content. For fine sand, C-OTPG-treated samples thawed at 3.42° C. for 20% plastic content and at 3.29° C. for 50% plastic content, showing relatively consistent thawing points.

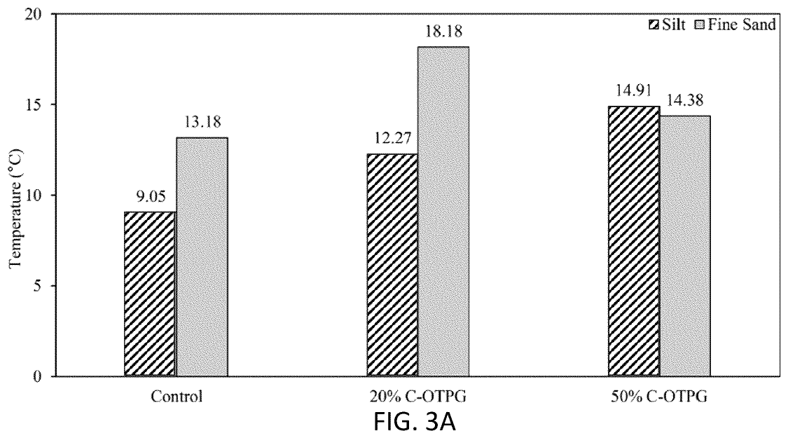

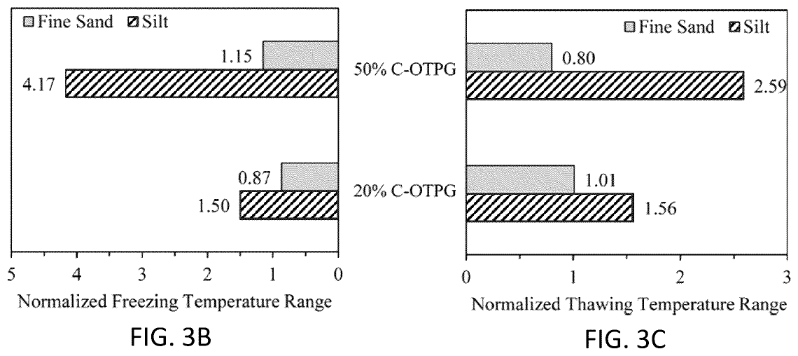

FIG. 3A shows the thermal hysteresis activity for control samples of silt at 9.05° C. and for control samples of fine sand at 13.18° C. For silt treated with high or low amounts of C-OTPG, the thermal hysteresis activities were 14.91° C. and 12.27° C., corresponding to increases of 65% and 36%, respectively. C-OTPG-treated silt with 50% plastic content showed the highest thermal hysteresis activity among all treatments. For fine sand, the thermal hysteresis activities for high and low amounts of C-OTPG were 14.38° C. and 18.18° C., corresponding to increases of 9% and 38%, respectively.

FIGS. 3B and 3C show the influence of plastic content on the freezing and thawing phase changes. A value greater than 1 means the freezing or thawing phase is longer than for the control soil, and vice versa for a value less than 1. The plastic-mixed soils, except for fine sand mixed with 20% C-OTPG, showed a prolonged temperature range. This effect is almost 3 times more pronounced for high amounts of C-OTPG. In the thawing phase, silt-mixed plastics exhibited an extended temperature range. Similar to the freezing phase, high C-OTPG shows almost 2.5 times the thawing effect on silt. Plastic-mixed fine sand thawed at a rate similar to or faster than control fine sand.

Based on freezing point and thermal hysteresis (TH) activity, C-OTPG influences the thermal characteristics of both silt and fine sand. For all mix designs, C-OTPG with silt lowered the freezing point by 39% compared to control siliceous silt. Similarly, for fine sand, high C-OTPG is more effective, reducing the freezing point by 14%. For lower amounts of plastic, C-OTPG remains effective (51%) for fine sand. Additionally, silt with C-OTPG treatment increased thermal hysteresis activity by 13% for high quantities of plastic and 6% for low quantities of plastic. High C-OTPG treatment also increased thermal hysteresis activity by 5% for fine sand. Thus, using 20% C-OTPG can achieve maximum depression of the freezing point in siliceous materials.

To assess the molecular mechanisms by which plastic granules coated with biogenic carbon derived from algae (C-OTPG) reduce the freezing point of water in soil, DFT was used to examine two series of interactions: interactions between water molecules and this biogenic carbon, and interactions of water molecules and this biogenic carbon at the silica surface. The initial assessment was on the Interaction Sphere of the biogenic carbon, which contains numerous functional groups capable of interacting with water, as shown in FIG. 1B. Models included various configurations of water molecules interacting with active sites on the biogenic carbon characterized by polar oxygen-containing and nitrogen-containing functional groups. Subsequently, the assessment was expanded to evaluate how water molecules in the presence of biogenic carbon interact with silica surfaces, focusing on the potential of silica surfaces to influence ice crystallization and reduce the freezing point. Mechanisms by which biogenic carbon modifies the interactions at the silica interface include potentially altering the migration and freezing behavior of water in soil at the molecular level.

The adsorption energies demonstrate the strength and stability of these molecular interactions. The DFT-based energy calculations revealed adsorption energies indicating strong interaction forces at play, such as hydrogen bonding. The calculated adsorption energy values ranged from −8.5 to −16.8 kJ/mol, suggesting a robust affinity of water molecules toward the Interaction Spheres of the biogenic carbon. This suggested a high degree of water-molecule retention on the biogenic carbon surface.

These results provide a molecular-level confirmation of the ‘Water Attraction and Retention’ mechanism. The strong hydrogen bonds formed between the water molecules and the functional groups on the surface of the biogenic carbon effectively trap water at these sites. This trapping mechanism decreases the mobility of water molecules, thereby reducing their migration through the soil toward the frost front. From a thermodynamic perspective, the adsorption energies indicate a stable interaction, which could contribute to a lowering of the local freezing point. DFT calculations support that C-OTPG can mitigate frost heave by reducing the mobility of water in soil and lowering the freezing point. The strong interactions between water molecules and biogenic carbon, characterized by adsorption energies, effectively reduce the availability of free water molecules that can migrate and freeze, which influences the depression of the freezing point. This effect, in turn, helps curtail the formation of ice lenses (responsible for frost heave) thereby more effectively maintaining the structural integrity of infrastructure in cold climates.

Biogenic carbon has a chemically and structurally uneven adsorption landscape at least in part because of the presence of various functional groups and a potentially irregular arrangement of these groups. Due at least in part to the heterogeneity, the adsorption sites on biogenic carbon do not uniformly bind water molecules. Uniform binding of water molecules plays a role in forming the typical crystalline structure of ice. DFT calculations show that when water molecules are adsorbed onto the uneven, non-uniform sites of biogenic carbon, the typical arrangement of the water molecules becomes disrupted. This disruption hinders the orderly lattice arrangement required for ice crystallization, effectively inhibiting the formation of ice at the molecular level.

Interactions between water molecules and biogenic carbon occur not only in the bulk but also at interfaces (e.g., silica surfaces), where they influence the physical state and behavior of water. At these interfaces, biogenic carbon can modify the arrangement and dynamics of water molecules, potentially preventing their organization into the structure of an ice crystal and altering their freezing point. By disrupting the typical structural arrangement and interaction dynamics of water molecules at the molecular level, these interactions could impede the formation of ice, thereby providing a molecular-level explanation for the observed depression in the freezing point and the reduction in susceptibility to frost heave.

Silica surfaces are typically hydrophilic at least in part because of the presence of silanol (Si—OH) groups, as shown in FIGS. 1A and 1B. These groups form hydrogen bonds with water molecules. The first layers of water molecules adsorb onto the silica surface through these bonds, resulting in a highly ordered structure. Subsequent layers, though less structured than the initial layer, show ordering influenced by surface interactions. As these layers accumulate, the overall structure increasingly resembles that of bulk water, yet the underlying surface interaction continues to influence the dynamics of the water molecules. Ice nucleation occurs heterogeneously at this interface, where the structured water facilitates the formation of an ice-like structure, even under conditions where bulk water remains liquid. This structuring lowers the energy barrier for forming an ice lattice. Once nucleation begins, ice crystals grow by incorporating adjacent water molecules into the lattice. This growth is influenced at least in part by various factors including temperature, vapor saturation, impurities, and surface properties. By altering the arrangement of water molecules at the silica surface, it is possible to suppress ice formation, thereby preventing the structural development of an ice crystal and contributing to the suppression of ice formation. In systems where biogenic carbon is present, the biogenic carbon can modify the processes of ice nucleation and growth.

Two mechanisms by which biogenic carbon suppresses the formation of ice on silica surfaces were assessed. The first involves the chemical functionalization of the silica surface, where biogenic carbon acts as a site that can inhibit ice formation. To reduce computational costs, the models focused on the Interaction Spheres of biogenic carbon rather than the entire molecule, evaluating their adsorption on models of the silica surface. The DFT results indicate that biogenic carbon has a propensity to adsorb onto the silica surface through hydrogen bonding, exhibiting high adsorption energy. When comparing the adsorption energies of different Interaction Spheres of biogenic carbon (E_{ads}=−33.8, −36.4, −45.1 kcal/mol) to the adsorption energy of a single water molecule on the silica surface (E_{ads}=−24.9 kcal/mol), biogenic carbon appeared to outcompete water in this adsorption scenario. This allowed biogenic carbon to disrupt the typical water arrangement on the silica surface, effectively suppressing the crystallization of ice. Additionally, the adsorption of biogenic carbon can alter the surface texture, introducing roughness that further decreases the likelihood of water crystallization. This surface roughness disrupts the structural continuity that leads to the formation of an ice lattice, thereby reducing the potential for ice nucleation and growth on the silica surface.

Biogenic carbon includes a structurally and chemically heterogeneous surface, enriched with oxygen-containing functional groups and nitrogen-containing functional groups. Due at least in part to the high electronegativity of these polar groups, they carry partial negative charges on the oxygen and nitrogen atoms, enhancing their capability to act as effective acceptors and donors of hydrogen bonds. This alteration increases the surface's polarity and capacity for hydrogen bonding. The DFT results provide an insight into the interactions of water molecules at silica surfaces modified by biogenic carbon.

When biogenic carbon is adsorbed onto the silica surface, it modifies the surface properties, enhancing the surface's affinity for water molecules. This is due at least in part to the alignment and dense packing of these polar groups, which provide multiple binding sites for water molecules. Consequently, water molecules are more likely to adsorb onto these modified surfaces and are more effectively retained. This enhanced adsorption plays a role in altering the migration and crystallization behavior of water. By trapping water molecules through strong hydrogen bonds and polar interactions, the biogenic carbon holds the water in place, limiting its mobility. This immobilization contributes to preventing the migration of water molecules toward the frost front, where freezing and the subsequent formation of ice lenses typically occur. Additionally, the adsorption energies of water molecules on the biogenic carbon (−23.1, −16.8, −27.7 kcal/mol) support the thermodynamic feasibility of this process.

The irregularity introduced by the biogenic carbon disrupts the orderly arrangement that allows the crystallization of water molecules into ice, thus reducing the likelihood of crystallization even under freezing conditions. Therefore, the presence of biogenic carbon on silica surfaces acts as a barrier that impedes the normal freezing process, potentially preventing the formation of structured ice crystals.

A computational analysis of the interactions between biogenic carbon and silica surfaces show a strengthening of the adsorption of biogenic carbon onto silica surfaces when water molecules were introduced into the system. This strengthening was demonstrated by the shortening of hydrogen bond lengths and an increase in adsorption energy from −33.8 kcal/mol to −34.7 kcal/mol for biogenic carbon in the presence of water molecules. When multiple water molecules interact with the entire biogenic carbon adsorbed on silica, the overall effect on adsorption can be further enhanced, indicating even stronger interactions and more stabilization. This phenomenon indicates a strengthening of the interaction between biogenic carbon and silica, due at least in part to electronic factors. The interaction of water molecules with biogenic carbon can cause polarization and charge redistribution at the structure of the biogenic carbon, enhancing electrostatic attractions between the biogenic carbon and silica. The overall stability of the system was improved by these interactions, suggesting a thermodynamically favorable arrangement that results in a more tightly bound state, as demonstrated by the observed shortening of bond lengths. This sequence of silica-carbon-water results in a more stable and enhanced attachment of biogenic carbon to the silica surface, which influences mechanisms for the suppression of ice. The strengthened attachment allowed the biogenic carbon remain effectively in place, serving as a barrier that disrupts the direct interaction of water molecules with the silica surface, thus inhibiting ice nucleation and propagation.

Another potential mechanism through which biogenic carbon suppresses ice formation at silica surfaces was assessed. This mechanism involved the strategic placement of biogenic carbon over layers of water molecules already adsorbed on the silica surface. This configuration was assessed using DFT modeling to understand how biogenic carbon could act as a capping layer influencing the behavior of water molecules. The computational models positioned biogenic carbon directly above water-saturated silica surfaces to simulate the possible interaction between biogenic carbon and the water molecules adsorbed on silica. The DFT results showed that it can form hydrogen bonds with the adsorbed water molecules on silica, with an adsorption energy of −31.4 kcal/mol. This negative adsorption energy indicated a strong interaction and high thermodynamic stability. An energy that is more negative indicates a more favorable adsorption process. This interaction stabilizes the water layer while restricting the mobility and arrangement of water molecules that they need for ice nucleation and growth. The capping effect of biogenic carbon blocks pathways for water molecules to align into the lattice that leads to the crystallization of ice. Additionally, water molecules form hydrogen bonds with both the biogenic carbon's functional groups and the silica's silanol groups, effectively bridging the two materials. This network of hydrogen bonding not only pulls the biogenic carbon closer to the silica surface but also can enhance the orbital overlap of bonding electrons, leading to stronger covalent interactions.

Moreover, the presence of biogenic carbon above the water layer introduces a physical barrier. This barrier not only adds an additional layer of complexity to the water-silica interface, but also modifies the local microenvironment. Changes in the microenvironment, such as altered silica surface polarity and the potential introduction of other dipole interactions, contribute further to the suppression of ice formation. These factors collectively enhance the silica surface's resistance to freezing even under conditions typically conducive to the development of layers of ice.

These mechanisms demonstrate how oil-treated plastic granules coated with biogenic carbon actively modifies the kinetic pathways and thermodynamic pathways of ice formation in soil. Biogenic carbon can be effectively used to control ice formation, manage frost heave, and enhance the durability of infrastructure in cold climates. This strategic use of biogenic carbon highlights its potential to address frost heave and related issues, showcasing its versatility and efficacy in environmental management and infrastructure protection. In addition to its capabilities at suppressing the formation of ice, algal biogenic carbon demonstrates a valuable capacity for environmental remediation, such as immobilizing contaminants of deicing salt within soil matrices. Algal biogenic carbon can effectively interact with chloride ions (Cl) through mechanisms of direct adsorption and cation (Na) bridging. The DFT calculations found adsorption of Cl to the biogenic carbon surface, facilitated by hydrogen bonding and electrostatic attractions between the ions and the biogenic carbon's active sites (mostly functional groups). These interactions stabilize the contaminants and prevent their leaching into groundwater, a concern in cold climates where deicing salts are extensively used. This dual functionality of algal biogenic carbon, as both a method for suppression of ice and a strategy for environmental protection, suggests its potential for broad application in cold regions.

Although this disclosure contains many specific embodiment details, these should not be construed as limitations on the scope of the subject matter or on the scope of what may be claimed, but rather as descriptions of features that may be specific to particular embodiments. Certain features that are described in this disclosure in the context of separate embodiments can also be implemented, in combination, in a single embodiment. Conversely, various features that are described in the context of a single embodiment can also be implemented in multiple embodiments, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

What is claimed is:

1. A mixture comprising:
carbon-coated oil-treated plastic particles; and
particles comprising geomaterial.

2. The mixture of claim 1, wherein the carbon-coated oil-treated plastic particles comprise polyethylene terephthalate particles coated with waste vegetable oil and biogenic carbon.

3. The mixture of claim 2, wherein the biogenic carbon is derived from algal biomass.

4. The mixture of claim 1, wherein the geomaterial comprises silt, soil, sand, or any combination thereof.

5. The mixture of claim 1, wherein the carbon-coated oil-treated plastic particles lower the freezing point of the geomaterial.

6. The mixture of claim 1, wherein the carbon-coated oil-treated plastic particles raise the thawing point of the geomaterial.

7. The mixture of claim 1, wherein the carbon-coated oil-treated plastic particles suppress ice crystallization at a surface of the particles comprising geomaterial.

8. The mixture of claim 1, wherein a particle size of the carbon-coated oil-treated plastic particles is in a range of 250 μm to 350 μm.

9. The mixture of claim 1, wherein the mixture comprises 5 wt % to 75 wt % of the carbon-coated oil-treated plastic particles.

10. The mixture of claim 8, wherein the mixture comprises 20 wt % to 50 wt % of the carbon-coated oil-treated plastic particles.

11. A method of treating the soil at a building site, the method comprising:
combining carbon-coated oil-treated plastic particles and geomaterial particles to yield a mixture; and
providing the mixture in a built environment to enhance soil stability under freezing conditions.

12. The method of claim 11, wherein the carbon-coated oil-treated plastic particles comprise polyethylene terephthalate particles coated with waste vegetable oil and biogenic carbon.

13. The method of claim 12, wherein the biogenic carbon is derived from algal biomass.

14. The method of claim 11, wherein the geomaterial particles comprise silt, soil, sand, or any combination thereof.

15. The method of claim 11, wherein a particle size of the carbon-coated oil-treat plastic particles is in a range of 250 μm to 350 μm.

16. The method of claim 11, wherein combining the carbon-coated oil-treated plastic particles and geomaterial particles lowers the freezing point of the geomaterial in the geomaterial particles.

17. The method of claim 11, wherein combining the carbon-coated oil-treated plastic particles and geomaterial particles raise the thawing point of geomaterial in the geomaterial particles.

18. The method of claim 11, wherein combining the carbon-coated oil-treated plastic particles and geomaterial particles suppress ice crystallization at a surface of the geomaterial particles.

19. The method of claim 11, wherein the mixture comprises 5 wt % to 75 wt % of the carbon-coated oil-treated plastic particles.

20. The method of claim 11, wherein the mixture comprises 20 wt % to 50 wt % of the carbon-coated oil-treated plastic particles.
